(19) United States
(12) Patent Application Publication
(10) Pub. No.: US 2008/0029410 A1
(43) Pub. Date: Feb. 7, 2008

(54) KIT FOR SECURING RECORDS

(76) Inventor: Sherie Dodsworth, Los Altos, CA (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/833,162

(22) Filed: Aug. 2, 2007

Related U.S. Application Data
(60) Provisional application No. 60/834,969, filed on Aug. 2, 2006.

(51) Int. Cl. B65D 69/00; B42F 13/00; B65D 85/57

(52) U.S. Cl. 206/223; 206/232; 206/307.1; 206/308.1; 402/74

(57) ABSTRACT

A kit for securing records comprising a case, a binder attached to the case and a plurality of sections attached to the binder. Each section comprises a class of similar records to be secured and includes a color-coded divider that identifies the section. Each section further comprises at least one record protector, at least one preprinted color-coded label corresponding in color to color-coded divider with the label attached to the record protector and instructions for assembling and maintaining records associated with the section.

### RELATED APPLICATIONS

The present application claims priority to and the benefit of U.S. Provisional Patent Application Ser. No. 60/834,969, filed Aug. 2, 2006 and entitled “KIT FOR SECURING RECORDS”, the disclosure of which is incorporated, in its entirety by reference.

### THE FIELD OF THE INVENTION

The present invention relates to storage equipment. More particularly, the invention relates to a portable device wherein important records may be centrally filed and organized.

### THE RELEVANT TECHNOLOGY

Important records and documents of individuals are vitally important, but are usually difficult to access quickly. Filing systems range from various stacks of papers placed around the owners domicile to massively reinforced, fireproof filing cabinets. Observational data shows that individuals organize their vital records and documents in one of two methodologies, some individuals implement organized chaos by storing important documents in boxes, folders or piles of paper that are not so strategically placed around the house, while other individuals are continuously organizing and storing documents in detailed files and placed in large and cumbersome filing cabinets.

Despite the desire to organize and store important documents, the storage methods typically occupy out-of-the-way storage areas. This makes the records difficult to access in times of an emergency. During times of an earthquake, flood, hurricane or other disaster, an individual is not able to quickly gather and transport their vital records with them. Additionally, the storage methods are only known by the original organizer, making it difficult if not impossible for others to find documents if necessary. Often times, when an individual becomes incapacitated or dies, relatives and beneficiaries have great difficulty in finding information about property records, wills, bank accounts, health information and such.

Many emergency preparedness tools exist to help individuals and families decide what essentials such as food, water, and first aid materials to carry with them when they evacuate during an emergency. However, there is virtually no information to help individuals and families prepare their vital records, such as health, identity and financial records, in preparation for an emergency.

There are a variety of filing devices that have the ability to store files. Most of these types of filing devices have the disadvantage of not being portable but are rather very heavy and large. Smaller filing systems have the disadvantage of being susceptible to weather damage and unorganized filing of documents making it difficult to quickly find important documents.

There is therefore a need for a storage device that enables an individual to file all of their important records and documents in a systematically organized device that is not susceptible to weather damage and easily portable. This way, an individual may quickly locate, access and transport necessary records and documents. Additionally, if others need to find the individuals records or documents, they will be centrally located in an easily identifiable location.

### BRIEF SUMMARY OF THE PREFERRED EXAMPLES

This apparatus is a kit for securing records and documents. The kit may allow an individual to file and organize records and important documents so that they are well organized, quickly accessible and easily portable to be used with daily use, future planning and home disaster planning. The kit for securing records and documents may be used as a complete document organizer that includes a home filing system and a safe portable storage device preserving records and important documents in case of an emergency or natural disaster. By gathering these records and documents in a centralized manner, the kit for securing records may increase the convenience with which such records can be accessed while maximizing the safety of the documents during normal periods of storage.

In one example, the kit for securing records includes various types of records and documents such as documents frequently used in day-to-day life, documents to provide ownership, documents which are difficult to replace, and/or documents that provide information on the owner's financial situation. Such documents may include, without limitation, records, memorabilia, photographs, or other types of records.

In at least one example, the kit for securing records includes a sturdy zipping canvas case, a ringed binder, a filing assembly, multiple canvas pouches and/or pockets, a handle and/or shoulder strap and various planning guides and/or cards (e.g. Communication Plan Cards for communication with family members in case of separation during an emergency).

In at least one example, a sturdy canvas case may be sealable using a zipper or other sealable means as described below. The canvas case may also be constructed with weather-proof material that may be water-resistant and highly durable. This feature can allow for increased protection of the enclosed contents during storage of the kit and/or transportation of the kit. The case may be optionally manufactured from vinyl, leather or other materials.

The kit for securing records includes a filing assembly. The filing assembly includes section dividers used to provide guidelines on the documents that go in each section, color-coded labels listing important records and documents for easy organizing, custom forms used to assist the individual in document organization and emergency planning, and record protectors for storing records and documents. The filing assembly provides a straightforward method for organizing the individual's documents by simply locating the label that pertains to a specific record or document, applying the label to a record protector, and finally locating the record or document listed on the label to insert into the labeled record protector.

In at least one example, the kit for securing records may provide a means to organize records and important documents in a secure, easily accessible and highly portable kit. This may enable a user to have peace of mind knowing that all their records and important documents are in a single and portable location. An advantage of certain examples of the present invention is the ease with which the user may secure their documents when time is of the essence, or when friend or relatives need access to important documents if the user becomes incapacitated.

### BRIEF DESCRIPTION OF THE DRAWINGS

A more particular description of the invention briefly described above will be rendered by reference to specific examples thereof which are illustrated in the appended drawings. Understanding that these drawings depict only typical kits and are not therefore to be considered to be limiting of its scope, the kit for securing records will be described and explained with additional specificity and detail through the use of the accompanying drawings in which:

FIG. 1 is a perspective view of an example of the present invention when zipped shut and closed showing a kit for securing vital records;

FIG. 2 is perspective view of the kit for securing vital records of FIG. 1 when unzipped and folded open showing various components included in the kit such as the file assembly;

FIG. 3 is a perspective view of an example of the kit for securing vital records of FIG. 1 when unzipped and folded open depicting various section dividers and record protectors;

FIG. 4 is a front view of an example of the kit for securing vital records of FIG. 1 when unzipped and folded open.

### DETAILED DESCRIPTION OF THE PREFERRED EXAMPLES

The kit for securing records provides a highly organized and portable filing system for storing and cataloging records and important documents. In one example the kit includes a case, a binder coupled to the case, a plurality of sections coupled to the binder, at least one record protector, a plurality of pre-printed color coded label, and instructions for assembling and maintaining records associated with the section. Each section includes a class of similar records to be secured. In one example, pre-printed color-coded labels as part of the kit are provided specifically for use with home-based businesses. These color-coded labels may include labels for financial document, computer-related document, incorporation documents, and/or legal documents. In another example, the color-coded labels in a kit may include labels specific for organizing children's records. Such labels may include diplomas, memorabilia, certificates, school pictures, awards and/or recognitions. Other labels may also be provided for use in organizing records related to tax records. For ease of reference, one specific kit will be described below that includes color-coded labels for specifically organizing vital records. Such an example is representative only, and should not be construed as limiting the scope of the disclosure.

Turning now to the kit for securing vital records, the kit may include pre-printed color coded labels for organizing vital records. The labels may include labels for vital records and important documents, that include, without limitation, birth certificates, school graduation certificates, marriage certificates, death certificates, social security cards, driver's licenses, state issued identification cards, passports, visas, official pictures, military records, immigration records, naturalization records, family history documents, adoption records, custody agreements, divorce records, pet documentation, bank account information, credit card statements, credit reports, property deeds, mortgage documentation, home equity line of credit documentation, investment account information, stock certificates, treasure bond securities, college savings plan information, residential lease agreements, vehicle lease information, vehicle loan information, record of home improvement, pictures of property or home, utility bills, vehicle certificate of title, vehicle bill of sale, DMV registration, vehicle warranty documents, property warranty information, timeshare agreement, timeshare title, insurance annuity information, IRA information, retirement plan information, lists of beneficiaries, lists of personal possessions, value of personal possessions, pictures of personal possessions, health history record, immunization records, prescription information, insurance cards, medical insurance records, Medicare/Medicaid information, life insurance information, disability insurance information, property insurance information, disaster insurance information, vehicle insurance information, living trust or will documentation, power of attorney information, cemetery plot deeds, tax returns, tax information and other records.

The inclusion of vital records, as previously mentioned, in a common, conveniently portable location provides a system for storing and cataloging vital records and important documents. This may allow the records to be securely stored while still concurrently accessible and easily movable when necessary.

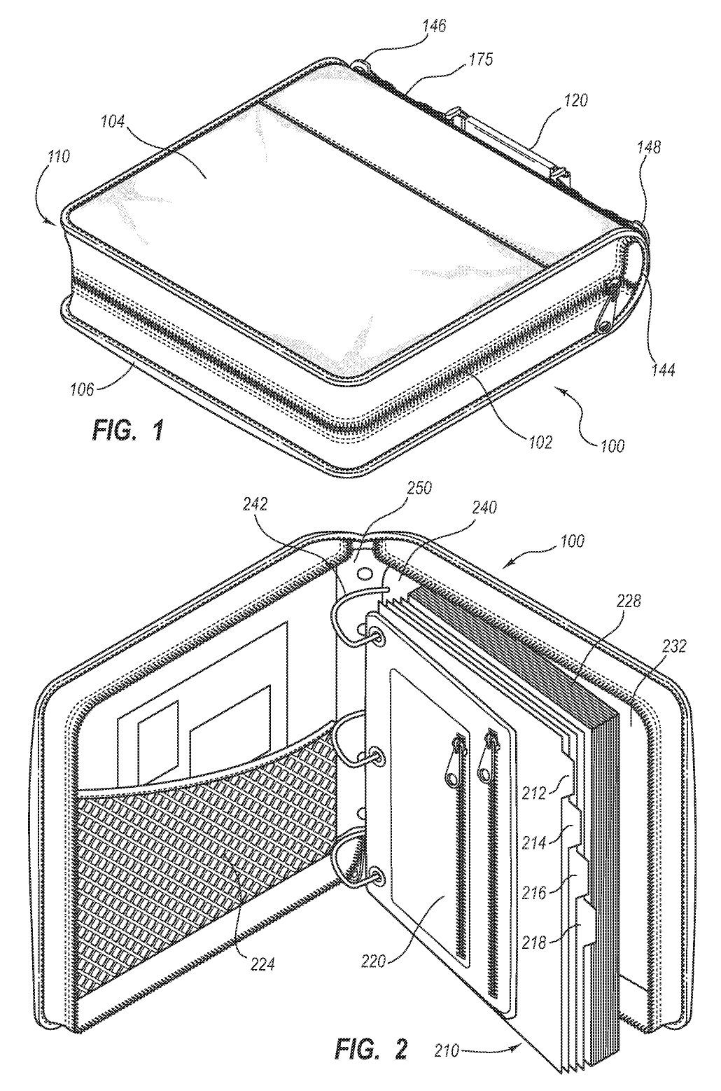

Referring initially to FIGS. 1-4, a kit for securing vital records 100 includes a case 110, a binder 240 associated with the inside rear cover of case 110, and a filing assembly 210. The filing assembly providing a means for organizing and filing vital records and important documents.

FIG. 1 illustrates an example of case 110. The case 110 includes two opposing covers 104, 106. The attached opposing covers 104, 106, conjointly attached along case spine 144, allow the case 110 to open and close. In the current example, the case 110 is manufactured with a durable, heavy-weight canvas material that may be water-resistant, tear-resistant, and/or stain-resistant. Another example may include a case made of vinyl, leather, rubber or other suitable material. Another example may include a protective plastic cover that encases case 110 to seal and protect the case from water and other elements.

Case 110 is made to hold standard sized paper and as such, the current example may have a height of at least 13 inches not to exceed 24 inches, a width of at least 6 inches not to exceed 18 inches and a thickness of at least 2 inches not to exceed 10 inches.

FIGS. 2-4 show that the inside of case 110 contains at least one flap 232 and at least one mesh pocket 224. The flap 232 is attached to case 110 on a back inside cover to hold binder 240 and filing assembly 210. The mesh pocket 224 is attached to front inside cover of case 110.

As seen in FIGS. 1-4, the portability of the case 110 is facilitated by a handle 120. The handle attached to outside of case spine 144. Another example may include a removable strap attached to attachments 146, 148 located at opposing ends of case spine 144. Another example may include an adjustable removable strap to allow users of different size and height to easily and comfortably transport kit 100.

As seen in FIGS. 1-4, the current example includes previously the opposing covers 104, 106, of case 110 which are sealed using zipper 102. Another example may include at least one nylon zipper, metal zipper, plastic zipper, watertight zipper or invisible zipper. Another example includes at least one non-zipper fastener to seal opposing covers 104, 106 of case 110.

The current invention includes an identification tag 175 attached to outside of case 110. The identification 175 may allow a user to easily identify the case 110 when desired, such as in emergency situation. Another example may include an identification tag that glows in the dark to allow easy acquisition in case of power failure or nighttime emergencies.

As depicted in FIGS. 2-4, binder 240 is inserted into flap 232 of case 110. In the current example, binder 240 is configured to slide in and out of case 110 as desired. Providing a binder 240 that is able to be separated from the case, may facilitate use of the kit, e.g. make the case 110 easier to deal with respect to organizational materials and the records associated therewith. Another example may include a binder integrally and permanently attached to case 110.

In the current example, binder 240 is a three-hole type binder having three evenly spaced rings 242 mounted on a backing 250 made of a plastic material such as polyvinyl chloride (PVC). Another example may include at least one two-ring binder, four-ring binder, five-ring binder or six-ring binder. Another example may include a backing made of plastic material other than PVC. Another example may include a backing made of metal.

As seen in FIGS. 2-4, filing assembly 210 of the current example includes at least one of section dividers 212, 214, 216, 218 associated with the binder 240, record protectors 228 attached to binder 240, zippered pouch 220 attached to binder 240. In another example, the recordable media sleeves 222 attached to binder 240. Another example may include label stickers attached to record protectors 228.

As depicted in FIGS. 2-4, section dividers 212, 214, 216, 218 include a plurality of color-coded partitions that separate vital records into like topics and/or sections. In the current example each section divider 212, 214, 216, 218, includes a color-coded tab associated therewith that identifies the section. The section includes color-coded section divider 212, 214, 216, 218, and record protectors 228 used to store records. Section dividers 212, 214, 216, 218, may be constructed from heavy-duty sheets of paper or plastic. Another example includes section dividers 212, 214, 216, 218, wherein instructions are printed on the dividers 212, 214, 216, 218, and instructions are section specific for the designated topic, e.g. instructions for filling out medical information sheet for medical personnel to use in an emergency. Another example includes section dividers 212, 214, 216, 218, wherein tips and helpful hints are printed on the dividers 212, 214, 216, 218, and are section specific for the designated topic, e.g. tips for protecting your identity in the section labeled Identification and Family Records.

Another example includes color-coded tabs 212, 214, 216, 218, further that include at least one pre-labeled tab, e.g. pre-labeled with a keyword and/or title of the section. Another example includes pre-labeled, color-coded tabs 212, 214, 216, 218, with such titles as Planning & Contacts section, Identification & Family Records section, Finance & Property section, Health & Medical section, Insurance & Taxes section, or Estate Planning & Retirement section. Other examples of titles for section dividers include, but are not limited to, Investment & Retirement Funds, Debt Management, Family History & Genealogy, Family Vacation Planning and the like.

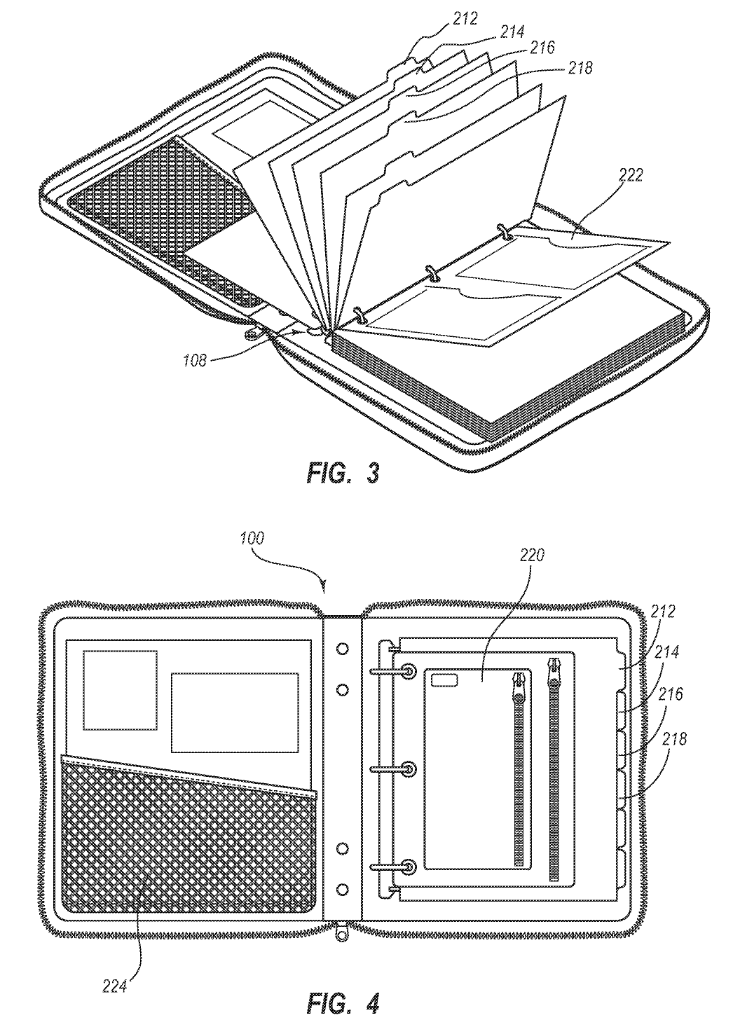

As depicted in FIGS. 2-3, record protectors 228 include a plastic protective sleeve attached to binder 240 in the desired section wherein record protectors 228 receive a selected record therein. Record protectors may be constructed to hold at least one paper record, digital record, medical records, photographs or similar item. Another example includes record protectors used for storing various shaped records including, without limitations, media sleeves such as CD/DVD sleeves and or pouches in which other records or content may be stored.

As depicted in FIGS. 2 & 4, a zippered pouch 220 has a rectangular shape and at least one zippered pocket. The zippered pocket may hold small objects, such as cash, keys, small USB drives, keepsakes and the like.

As previously described, the filing assembly 210 is an example of means for organizing and filing vital records and important documents. Thus, one example of the means for organizing and filing vital records and important documents may include a plurality of color-coded, labeled dividers used to classify and group records and documents into similar divisions. Further labels and stickers clarify what record and/or document is being stored in each of the various dividers.

The present invention may be embodied in other specific forms without departing from its spirit or essential characteristics. The described examples are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. A kit for securing records, comprising:
a case;
a binder coupled to the case;
a plurality of sections coupled to the binder, each section including a color-coded divider that identifies the section, at least one record protector, at least one preprinted color-coded label configured to be affixed to the record protector, the color-coded label corresponding in color to the color-coded divider, and instructions for assembling and maintaining records associated with the section; and
wherein the section comprises a class of similar records to be secured.

2. The kit of claim 1, wherein the case includes a handle and strap.

3. The kit of claim 1, wherein the case includes a water-resistant cover.

4. The kit of claim 1, further comprising a CD/DVD holder which fits on the binder.

5. The kit of claim 1, wherein the case further includes an identification tag.

6. The kit of claim 5, wherein the identification tag glows in the dark.

7. The kit of claim 1, further comprising a zippered pouch.

8. The kit of claim 1, wherein the color-coded labels include labels related specifically to vital records.

9. The kit of claim 1, wherein the color-coded labels include labels related specifically to documents for running a home-based business.

10. The kit of claim 1, wherein the color-coded labels include labels related specifically to childhood records, including academic records.

11. A kit for securing records, comprising:
a case with handle and attachable strap;
a binder coupled to the case;
a plurality of color-coded, pre-labeled dividers, and instructions for assembling and maintaining records associated with the dividers; and
at least one planning guide.

12. The kit of claim 11, wherein the planning guide comprises at least one basic outline for natural disaster planning, house evacuation planning, and immediate assistance planning.

13. The kit of claim 11, wherein the color-coded, pre-labeled dividers are labeled to organize and assemble vital records.

14. The kit of claim 13, wherein the vital records comprise at least one identification record, family records, financial records, property records, health records, medical records, insurance records, tax records and estate planning records.

15. The kit of claim 11, further comprising a CD/DVD holder which fits in the binder.

16. The kit of claim 11, further comprising a zippered pouch.

17. A kit for securing records, comprising:
a case with handle and attachable strap;
wherein the case is sealable and includes an identification tag;
a binder coupled to the case;
a filing assembly comprising a plurality of section dividers a plurality of record protectors and a zippered pouch, wherein the filing assembly is coupled to binder.
a mesh pouch, wherein the mesh pouch is attached to inside of case;
a plurality of sections coupled to the binder, each section including a color-coded divider that identifies the section, at least one record protector, at least one preprinted color-coded label configured to be affixed to the record protector, the color-coded label corresponding in color to the color-coded divider, and instructions for assembling and maintaining records associated with the section;
wherein the section comprises a class of similar records to be secured;
wherein each of the section dividers comprises at least one pre-labeled sections titled Planning & Contacts section, Identification & Family Records section, Finance & Property section, Health & Medical section, Insurance & Taxes section, or Estate Planning & Retirement section; and
wherein the record protectors receive at least one record or document.

18. The kit of claim 17, wherein the filing assembly includes record protectors for media storage.

19. The kit of claim 18, wherein the media storage comprises at least one CD, DVD, and Floppy Disk.

20. The kit of claim 17, wherein the kit further comprises an exterior protective cover.
